(19) United States
(12) Patent Application Publication
(10) Pub. No.: US 2008/0166207 A1
(43) Pub. Date: Jul. 10, 2008

(54) Adhesive Application Station for Binding Printed Material

(75) Inventor: Walter Baltensperger, Baar/Schweis (CH)

Correspondence Address: BACHMAN & LAPOINTE, P.C., 900 CHAPEL STREET, SUITE 1201, NEW HAVEN, CT, 06510, US

(73) Assignee: SOGNO AG, Baar (CH)

(21) Appl. No.: 11/909,988

(22) PCT Filed: Mar. 29, 2006
(86) PCT No.: PCT/CH2006/000181

§ 371 Date: Oct. 22, 2007

(30) Foreign Application Priority Data
Mar. 30, 2005 (CH) 551/05

(51) Int. Cl. B42C 9/00

(52) U.S. Cl. 412/37

(57) ABSTRACT

An adhesive application station comprising a device for binding stacked printed material using a free-flowing or liquefiable adhesive. The adhesive application station comprises, in the sliding surface for the printed materials, at least one outlet for the adhesive and a dosing device which is supplied with adhesive and can be closed by an actuator in a manual, mechanical, electronic and/or sensor-controlled manner. At least two separately closing supply lines for the adhesive end in a common supply channel for the dosing device, directly upstream of the dosing device, said lines each comprising an adhesive reservoir and a pump. In this way, especially a plurality of adhesives can be successively treated on the same installation without any retrofitting.

### BACKGROUND OF THE INVENTION

The invention relates to an adhesive application station in a device for binding stacked printed products by means of a free-flowing or liquefiable adhesive, which station comprises, in the sliding surface for the printed products, at least one outlet opening for the adhesive and a dosing device which is supplied with adhesive and can be closed by an actuator in a manual, mechanical, electronic and/or sensor-controlled manner.

For the production of books, periodicals, brochures and the like, printed products of all kinds are first brought together, stacked and fixed in a clamping device by means of a clasp. Then the back surface of the stack is milled flat and at the same time roughened. This allows the subsequently applied adhesive to be absorbed better and take effect better. If the back surface is insufficiently pretreated, the adhesion of the adhesive is poor and the binding quality is reduced. As a consequence of this, individual leaves come out during use or the bound printed products fall apart. However, the applied layer of adhesive must not only firmly bind in each individual page, but also be flexible enough to allow the bound printed products to be leafed through without any problem.

Known adhesives are cold-setting adhesives, hot-setting adhesives or in particular hot-melt adhesives, such as thermoplastic adhesives; these are, for example, polyurethanes, polyolefins, such as polyethylene and polypropylene, ethyl vinyl acetate (EVA), polyethylene terephthalate (PET) and/or polystyrene.

Generally, the stacked printed products mentioned are not only glued together on the back surface but also cased in a cover, which gives the adhesive bonding region increased strength and stability.

According to the known prior art, the back of the stack is drawn over an application roller, which dips into a tray with liquid adhesive. However, when an adhesive application roller turns, not only is adhesive conveyed to the back of the stack of printed products but there is also the disadvantage that oxygen is introduced into the liquid adhesive. As a result, the quality of the adhesive can be impaired considerably. This is the case especially with adhesives that react with atmospheric moisture, for example a moisture-reactive polyurethane adhesive, in the case of which a pre-reaction with the isocyanate group takes place as a result of the infiltrating atmospheric moisture.

Because, for example, dirt particles can get into the liquid adhesive when an adhesive application roller turns, the quality of the adhesive can be made to deteriorate still further. Infiltrating oxygen and/or contamination may bring about a considerable reduction in the adhering properties of adhesives.

EP 1156931 B1 brings about a considerable improvement with respect to the harmful effect of atmospheric oxygen. The basic diagrams taken from this European patent, as shown by FIGS. 1 and 2, represent the binding region of an adhesive application head of an adhesive application station in plan view and in section.

FIG. 1 shows a stack of printed products 10 on an adhesive application head 12 of an adhesive application station 14 (FIG. 2). A sliding surface 16 of a nozzle block 18 of the adhesive application head 12 is penetrated by an outlet slit 20 for liquefied adhesive 52 (FIG. 2), extending at right angles to the direction of advancement E of the printed products 10, whereby an application edge is formed. The slit width s of the outlet slit 20 is around 0.1 mm-1 mm, in particular approximately 0.2 mm. This slit width s is generally predetermined, but it may also be possible for it to be set, for example in a way corresponding to U.S. Pat. No. 6,271,794 A.

The sliding surface 16 is laterally delimited by a fixing stop 22 with a first guiding surface 24, incorporating a directing aid 24, and a holddown device 26 with a second guiding surface 28, for a printed product 10. The holddown device 26 can be displaced and exactly positioned in the direction of the double-headed arrow 30, which extends parallel to the outlet slit 20. The holddown device 26 carries a slide 32, which can be pressed into the holddown device 26 counter to a resilient force within a narrow tolerance range t in the direction of the double-headed arrow 34, likewise extending parallel to the outlet slit 20. The slide 32 has a third guiding surface 36 for stacked printed products 10, likewise with a directing aid 36a. Both this third guiding surface 36 and the first guiding surface 24 are angled away and widen as directing aids 24a, 36a in a direction opposite the direction of introduction E for stacked printed products 10. The narrow tolerance range t for the spring-return slide 32 is delimited by a bore 38 in the holddown device 26 and a bolt 40 projecting into this bore 38 from the slide 32.

For binding stacked printed products 10, first the holddown device 26 is positioned with the slide 32 in a way corresponding to the minimum thickness d of the stacked printed products 10 and is set, for example with a screw. In the case of a tolerance range t of, for example, 0.5 mm for the thicknesses d of the stacked printed products 10, the width g of the sliding surface 16 is set to the distance d and the tolerance range t, provided that the slide 32 is pressed in flush with respect to the second guiding surface 28 with maximum tolerance t. When stacked printed products 10 are introduced, the pressing in of the slide 32 takes place when said products are pushed along directing aids 24a, 36a of the first and third guiding surfaces 24, 36. The adhesive application commences in a mechanical, electronic and/or sensor-controlled manner when the outlet slit 20 is reached and is ended when the printed product 10 leaves the region of the outlet slit 20.

Both the holddown device 26 and the slide 32 seal the outlet slit 20 when and where they rest on the sliding surface 16.

When the stacked printed products 10 are guided over the outlet slit 20, they are pushed by the slide 32 onto the first lateral guiding surface 24. The second guiding surface 28 does not act as such in the present case; the stacked printed products 10 slide along the third guiding surface 36 with the directing aid 36a. During the binding according to FIG. 1, differences in terms of the thickness d of the stacked printed products 10, both within the same stack and from stack to stack, are automatically compensated; an adhesive discharge alongside the printed products 10 cannot occur, not only avoiding loss of adhesive 52 but also avoiding the formation of unsightly strands of adhesive.

FIG. 2 shows a basic diagram of an adhesive application head 12 of an adhesive application station 14 with a slit nozzle 42, which comprises the outlet slit 20 shown in FIG. 1 and a dosing shaft 44, which is guided in a bore 38 of the adhesive application head 12 and has a longitudinal slit 46. This dosing shaft extends over the length of the outlet slit 20 of the sliding surface 16, onto which stacked printed products 10 are guided over a sloping introduction ramp 61.

Arranged underneath the dosing shaft 44, which is rotatable in the direction of the double-headed arrow 48, is an adhesive reservoir 50, which is formed as a pressure chamber and is filled with a dissolved or molten adhesive 52. Arranged in a pressure accumulator 54 is a pressure cylinder 56 with a plunger 58, which is movable in the direction of the double-headed arrow 60 and protrudes into the adhesive reservoir 50. A pressure equalizing system is formed as a result. A pressure in the adhesive reservoir 50 is determined according to EP 1156931 B1 by the cross-sectional ratio of the pressure cylinder 56 to the plunger 58 and the pressure in a pre-chamber 63 of the pressure accumulator 54, this pressure lying for example in a range between 0.7 and 0.8 bar.

The inventor has undertaken the object of providing an adhesive application station of the aforementioned type which not only ensures a low loss of adhesive and the introduction of a small amount of oxygen when the type of adhesive is changed over but additionally reduces the effort involved considerably. Greatly reduced downtimes increase the productivity of such an installation to a substantial extent.

### SUMMARY OF THE INVENTION

The object is achieved according to the invention by at least two separately closable supply lines for the adhesive, which each have an adhesive reservoir and a pump, opening out into a common supply channel of the dosing device, directly upstream of the dosing device. Special and further-reaching objects to be achieved by the adhesive application station are the subject of dependent patent claims.

The dosing device according to the invention allows in particular that a number of adhesives can be used on the same installation without any retrofitting.

The dosing device operates as a closed system, with the result that no oxygen is introduced into the adhesive. The dosing device is preferably formed as a dosing shaft with a longitudinal slit, which corresponds with the outlet slit and the supply channel. For design details, reference is made to EP 1156931 B1, which was acknowledged as prior art at the beginning. Instead of the longitudinal slit, other means, for example holes or a number of short slits formed along a surface line, may be provided.

The separately closable supply lines, which lead to reservoirs with any adhesives, expediently different adhesives, have a shut-off element, for example in the form of a slide, a flap, a solenoid valve or a cock. The shut-off elements can be actuated by an actuator in a manual and/or program-controlled manner. Program-controlled shut-off elements are actuated in such a way that a shut-off element of one supply line closes before the respective shut-off element of another supply line can open, which corresponds to the function of an OR valve.

According to one variant, it is also possible, for example when using more than two shut-off elements or supply lines, to arrange for opening or closing of the shut-off elements concerned to occur in such a way that two or more supply lines are open simultaneously, while the other shut-off elements remain closed or are closed. In this way, adhesive types and/or components are mixed with one another before or during application, for example two-component adhesives. Variable pressure regulating regimes also allow the dosing of volumetric flows, whereby a required ratio of the adhesive types and/or components to be mixed in relation to one another is achieved.

Fitted with preference is a shut-off element which, as a result of the structural configuration, automatically has the effect that the adhesive is fed to the dosing device exclusively from one supply line. According to a first variant, this takes place by a nonreturn valve being fitted in each of the two supply lines. Such a nonreturn valve has, for example, a cylindrical inner space with frustoconical end faces tapering on both sides to a pipe, and a ball that is freely displaceable with play with respect to the cylinder jacket. Under the action of a return, this ball maintains sealing contact; when the adhesive is applied, sufficient material is allowed through between the ball and the cylinder jacket. A stop has the effect that the ball or some other closing body does not maintain sealing contact during the flow of material. According to a further variant, the shut-off element is a three-way cock, which can be changed over by a simple manual movement and closes one or the other supply line in an absolutely sealing manner.

The shut-off element is advantageously formed as a compact built-in unit. The opening of the two supply lines into the supply channel can be integrated in this built-in unit.

Provided that it allows a solution that it structurally satisfactory, three or even more closable supply lines may also open out into a common supply connector to the dosing device.

The decisive advantage of the solution according to the invention is that an adhesive type and/or component can be changed over in an adhesive application station within a minute or less, by the active supply line being closed and the inactive supply line with the already connected new adhesive being opened. In this case, the adhesive to be replaced is automatically expelled from the supply channel, the longitudinal slit of the dosing shaft and the outlet slit. Before the stack to be bound with a new adhesive is introduced, the small amount of expelled, no longer used, adhesive is wiped away. This cleaning, performed in a matter of seconds, takes the place of prior-art cleaning work that generally takes about half an hour.

### BRIEF DESCRIPTION OF THE DRAWINGS

The invention is explained in more detail on the basis of exemplary embodiments that are represented in the drawing and are also the subject of dependent patent claims.

In the schematic drawing:

FIG. 1 is FIG. 1 of EP 115 69 31

FIG. 2 is FIG. 2 of EP 115 69 31

FIG. 3 shows a basic diagram,

FIG. 4 shows a three-way cock in the two operating positions,

FIG. 5 shows a nonreturn valve with two supply lines,

FIG. 6 shows a variant of FIG. 5,

FIG. 7 shows a nonreturn valve with three supply lines, and

FIG. 8 shows a variant of FIG. 7.

### DETAILED DESCRIPTION

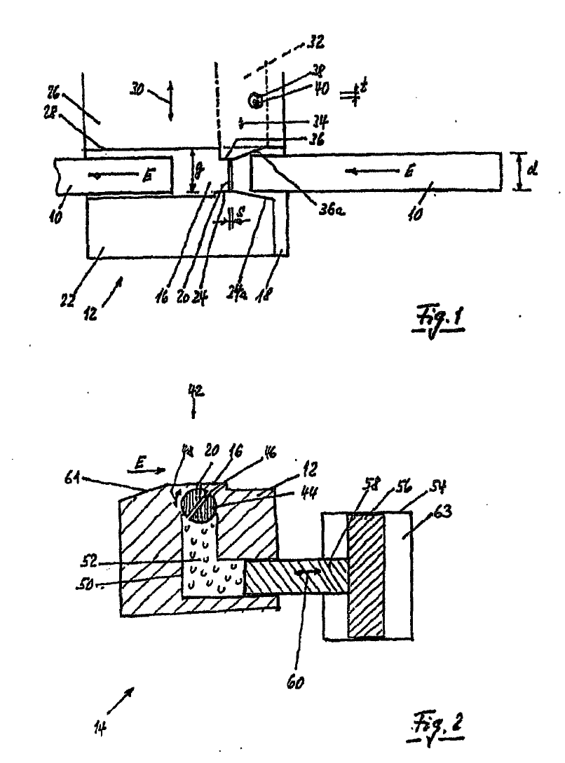

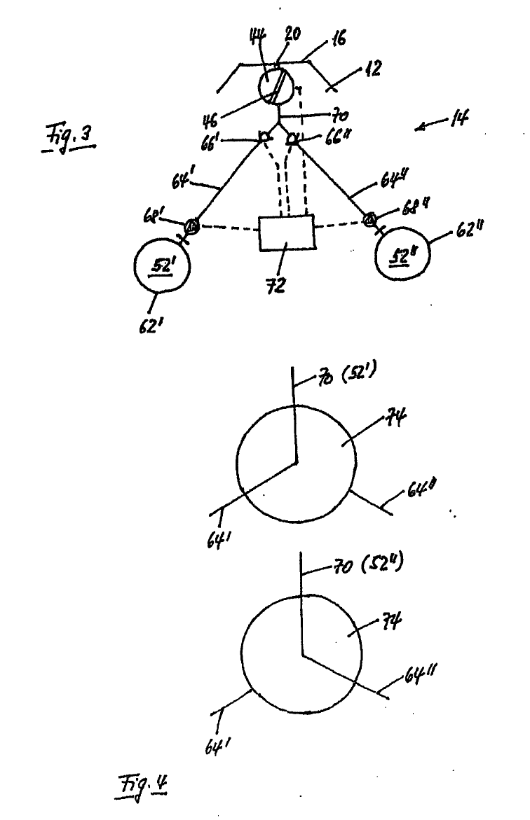

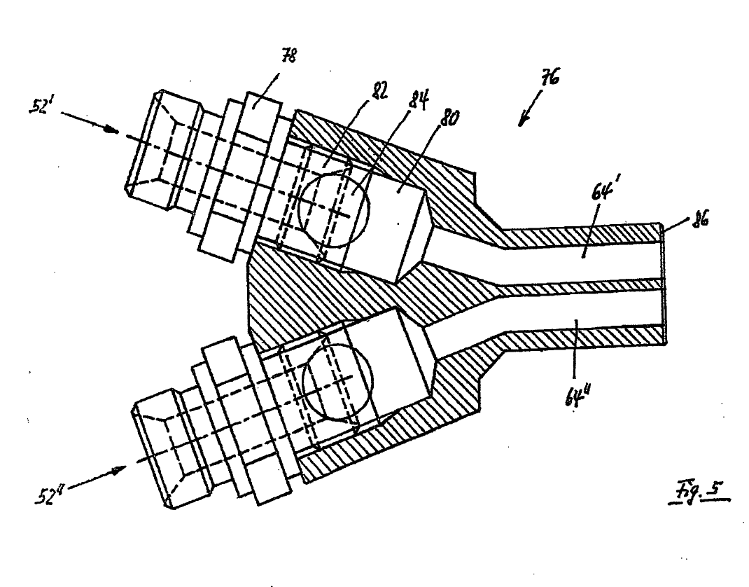

In FIG. 3, the adhesive application head 12 of an adhesive application station 14 is merely indicated. The sliding surface 16 for the back of the printed products 10 (FIG. 1) is interrupted in the transverse direction by an outlet slit 20 for the adhesive 52 (FIG. 2). Arranged directly underneath the outlet slit 20 is the dosing shaft 44 with the longitudinal slit 46; here, the dosing shaft 44 is in a position in which it closes the outlet slit 20.

A first supply line 64′ is detachably flange-mounted on a first adhesive reservoir 62′ with a first adhesive 52′. This supply line can be closed by a first shut-off element 66′, formed as a solenoid valve. A first pump 68′ pumps the first adhesive 52′ in the direction of the dosing shaft 44.

A second supply line 64″ is detachably flange-mounted on a second reservoir 62″ with a second adhesive 52″. This supply line can be closed by a second shut-off element 66″, formed as a solenoid valve; a second pump 68″ pumps another, second adhesive 52″ in the direction of the dosing shaft 44.

The first and second supply lines 64′, 64″ are brought together to form a common supply channel 70, which in the open position of the dosing shaft 44 corresponds with the longitudinal slit 46 of the latter.

A microprocessor 72 controls the process, which is indicated by dashed lines. When a printed product 10 (FIG. 1) reaches the outlet slit 20, the dosing shaft 44 is turned into the vertical position for the longitudinal slit 46, the active, first or second, shut-off element 66′, 66″, formed here as a solenoid valve, is opened and at the same time the active pump 68″ or 68″ is actuated. When a printed product 10 leaves the region of the outlet slit 20, the dosing shaft 44 is turned back in such a way that its longitudinal slit 46 lies outside the region of the outlet slit 20; the active pump 68′ or 68″ and/or the active shut-off element 66′, 66′ is immediately closed.

If a series of printed products 10 runs through continuously, it is also possible for only the dosing shaft 44 to be actuated. The shut-off element 66′ or 66″ and the pump 68, 68″ may then be switched to continuous operation.

If the left-hand side of FIG. 3 is active and the right-hand side is inactive, a change of adhesive from 52′ to 52″ can be performed within approximately 30 seconds; the remains of the first adhesive 52′ are expelled by the new adhesive 52″ and, thanks to the small amount, can be wiped away by a manual movement, for example with a doctor blade. The adhesive application station 14 is then already ready to operate with the new adhesive 52″.

In FIG. 4, a three-way cock 74 is represented in two operating positions. In the upper half of the figure, the first adhesive 52′ is fed to the supply channel 70, in its lower half the second adhesive 52″ is fed to it. The three-way cock 74 can be actuated by an actuator manually or under the control of the processor 72 (FIG. 3). The three-way cock 74 may be referred to as an OR valve.

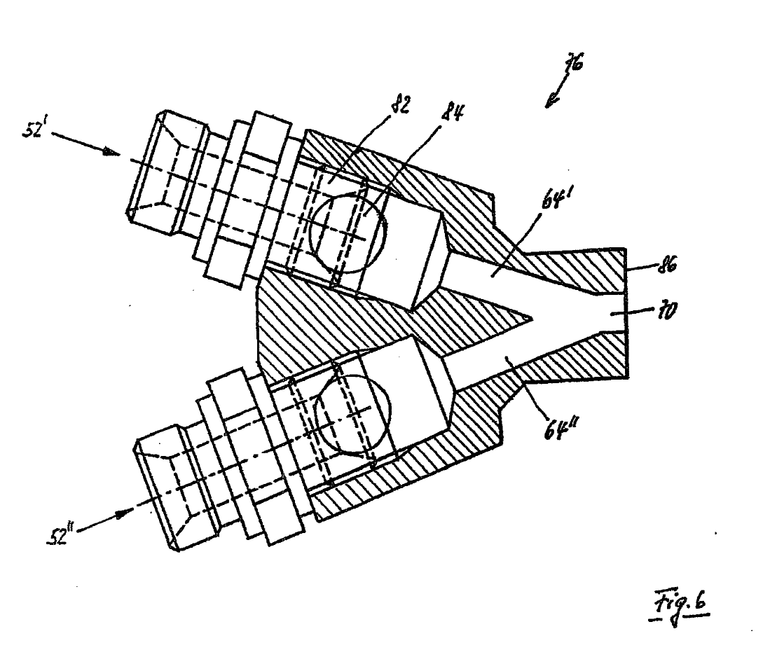

In FIG. 5, a nonreturn valve 76, a second type of OR valve, is represented. The nonreturn valve 76 is formed in one piece; the introduced first and second adhesives 52′, 52″ are characterized by an arrow. The supply lines 64′, 64″ open out via screw fittings 78 into the nonreturn valve 76. Formed upstream in a respective cylindrical cavity 80 is a tapering valve seat 82 for a ball 84, which prevents a backflow. Both balls 84 are depicted in the closed position. If adhesive 52′ or 52″ is pumped, the valve concerned opens. The adhesive concerned, adhesive 52′, 52″, flows in a separate continuation of the supply lines 64′, 64″ to the downstream end face 86 of the nonreturn valve 76. These separate discharges have the advantage that the return of one supply line 64′ into the other 64″ is minimal.

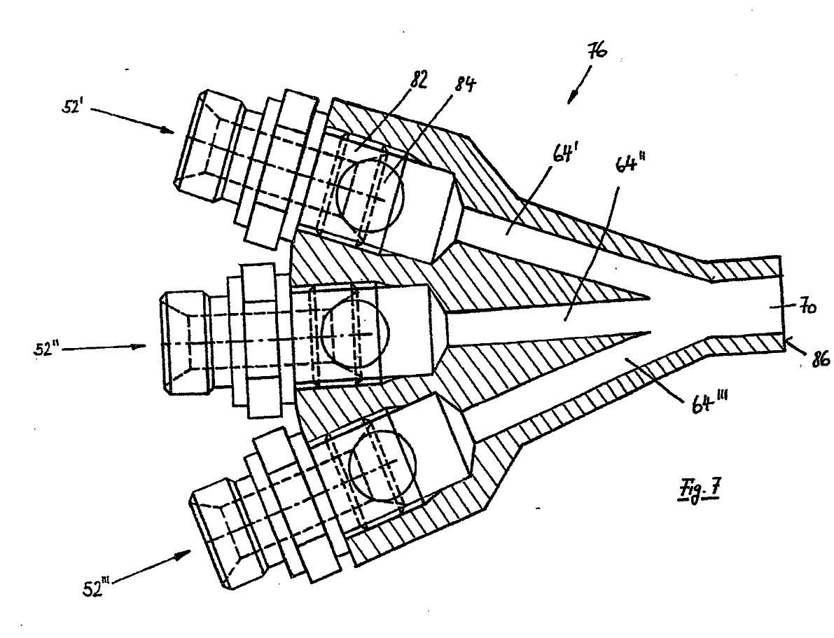

According to the variant of FIG. 6, the two supply lines 64′ and 64″ are already brought together in the nonreturn valve 76; the common supply channel 70 emerges from the downstream end face 86 of the nonreturn valve 76. As in FIG. 5, for the sake of simplicity, the stops of the ball 84 pressed away from the valve seat 82 are not depicted.

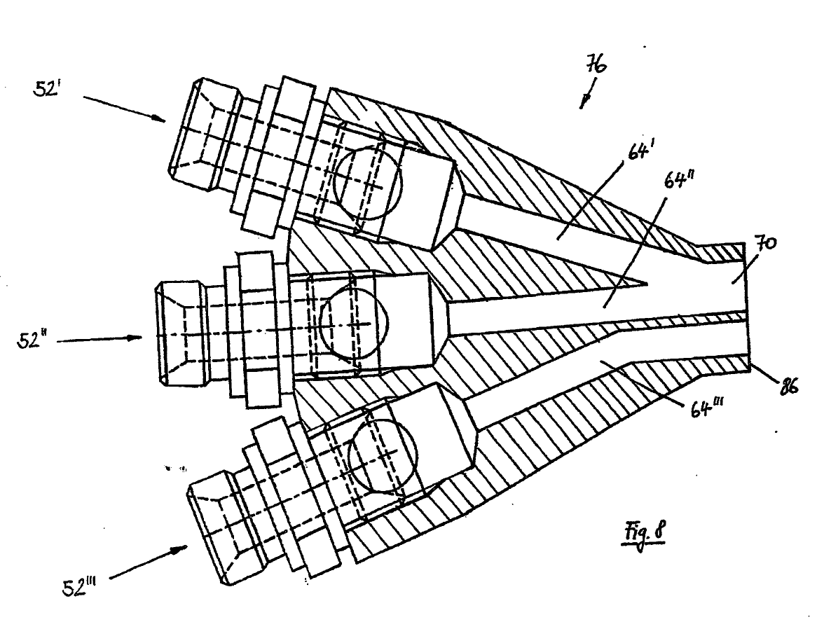

In FIG. 7, three supply lines 64′, 64″ and 64′″ are brought together in a nonreturn valve 76 to form a supply channel 70 lying at the end face 86. As in FIGS. 5 and 6, for the sake of simplicity, the stops of the ball 84 pressed away from the valve seat 82 are not depicted. FIG. 7 is set out in such a way that, at the time under consideration, in each case only one of the three supply lines 64′, 64″ or 64′″ is open, the other two are closed. Mixing of the adhesives 52′, 52″, 52′″ is consequently ruled out.

In a further exemplary embodiment (not represented), the opening and closing of the balls 84 according to FIG. 7 is configured in such a way that, at the time under consideration, in each case two supply lines 64′ and 64″, 64′ and 64′″ or 64″ and 64′″ are open. The third supply line in each case, supply line 64′, 64″ or 64′″, is then closed (and vice versa). This mode of configuration allows mixing of two adhesive types or components, for example 52′ and 52″, whereas a third, separate adhesive 52′″ is fed in when the two other supply lines, for example 64′ and 64″, are closed. By means of variable pressure regulating regimes, a desired, individual volumetric flow is also set for each of the supply lines 64′, 64″ and 64′″ . In this way, quite apart from the exact dosing of the adhesives 52′, 52″, 52′″, a ratio required when mixing two adhesive types or components, for example three parts 52′ and one part 52″, is achieved at the same time.

FIG. 8 shows a nonreturn valve 76, in which two supply lines 64′ and 64″ are brought together to form a supply channel 70 lying at the end face 86, whereas a third supply line 64′″ is taken independently to the end face 86. The exemplary embodiment allows simultaneous opening/closing of the two supply lines 64′ and 64″, whereby mixing of the adhesives 52′ and 52″ is achieved. The proportionate ratio can in turn be set by means of variable pressure regulating regimes, whereby, quite apart from the exact dosing, a ratio required when mixing two adhesive types or components is achieved. In the second switching state, the supply lines 64′ and 64″ are closed, whereas the supply line 64′″ is open. Consequently, a third, separate adhesive 52′″ is fed in.

In a further exemplary embodiment (not represented) according to FIG. 8, in each case only one of the supply lines 64′, 64″ or 64′″ is open, whereas the other two are closed.

A hot-melt adhesive, a molten thermoplastic adhesive, is generally used as the adhesive 52, 52′, 52″, 52′″.

1-10. (canceled)

11. In a device for binding stacked printed products having a sliding surface for the printed materials, an adhesive application station for feeding adhesive to the sliding surface of the device, the adhesive station comprises:
an adhesive outlet for directing adhesive to the sliding surface; an adhesive supply channel; a dosing device between the adhesive supply channel and the adhesive outlet; means for moving said dosing device between an open position for communicating the adhesive supply channel with the adhesive outlet and a closed position for blocking communication between the adhesive supply channel and the adhesive outlet; and at least two adhesive supply lines, each supply line communicating adhesive from an adhesive reservoir, by means of a pump, through a selectively closable valve means to the adhesive supply channel.

12. The adhesive station as claimed in claim 11, wherein the dosing device comprises a dosing shaft having a longitudinal slit, which in the open position communicates the adhesive outlet with the adhesive supply channel.

13. The adhesive station as claimed in claim 11, wherein the valve means is one of a slide, a flap, a solenoid valve, and a cock.

14. The adhesive station as claimed in claim 11, wherein the valve means is actuated by an actuator.

15. The adhesive station as claimed in claim 11, wherein the at least two supply lines open out into the supply channel via a valve.

16. The adhesive station as claimed in claim 15, wherein the valve is a nonreturn valve formed for each supply line.

17. The adhesive station as claimed in claim 16, wherein the nonreturn valve comprises a cylindrical inner space with a frustoconical valve seat and a ball that is longitudinally displaceable freely with play up to a stop.

18. The adhesive station as claimed in claim 15, wherein the valve is a three-way cock.
